(19) United States
(12) Patent Application Publication
(10) Pub. No.: US 2023/0179068 A1
(43) Pub. Date: Jun. 8, 2023

(54) MOTOR WITH FLUXRING

(71) Applicant: KEYANG ELECTRIC MACHINERY CO., LTD., Seoul (KR)

(72) Inventors: Hoecheon KIM, Anyang-si (KR); Youngcheol KIM, Ansan-si (KR)

(21) Appl. No.: 17/672,975

(22) Filed: Feb. 16, 2022

(30) Foreign Application Priority Data
Dec. 3, 2021 (KR) 10-2021-0172203

(51) Int. Cl. H02K 11/01; H02K 5/14

(52) U.S. Cl. CPC H02K 11/014; H02K 5/14

(57) ABSTRACT

Proposed is a motor having a flux ring in which the flux ring is fastened to a flux ring fastening part formed along the circumferential surface of a yoke.

### CROSS REFERENCE TO RELAYED APPLICATION

The present application claims priority to Korean Patent Application No. 10-2021-0172203, filed Dec. 3, 2021, the entire contents of which are incorporated herein for all purposes by this reference.

### BACKGROUND OF THE INVENTION

### Field of the Invention

The present disclosure relates generally to a motor having a flux ring. More particularly, the present disclosure relates to a motor having a flux ring in which a flux ring is fastened to a flux ring fastening part formed along the circumferential surface of a yoke so as to prevent the leakage of magnetism.

### Description of the Related Art

Generally, a seat of a vehicle is configured to slide forward and backward according to a body shape of a user.

A sliding device for using a vehicle seat normally includes a pair of tracks fixed parallel to a vehicle body floor, a pair of rails configured to move along the tracks by a lead screw mounted to each of the tracks and fastened to the lower surface of the vehicle seat, and a drive part connected to the pair of rails at opposite ends thereof, respectively, and configured to operate such that the rails move along the tracks. A motor is mounted to the drive part, and a rotating shaft of the motor extends to each of opposite sides so as to be connected to the pair of rails, respectively. While the motor operates, the pair of rails moves forward and backward along the pair of tracks.

Hereinafter, the structure of a motor according to a prior art will be described in detail.

The motor has an armature located at a center thereof, and cores are mounted on the circumference of the armature. The circumference of the armature on which each of the cores is mounted is covered by a casing. A yoke provided with a magnet is fastened to the inside of the casing and is located such that the longitudinal center of the yoke and the longitudinal center of the core correspond to each other.

In recent years, various R&D efforts have been made to reduce the consumption of electric current of a motor and to increase the efficiency of the motor. In order to solve these problems, Korean Patent Application Publication No. 10-2007-0060893 discloses “BLOWER MOTOR HAVING REDUCED CURRENT CONSUMPTION”.

The prior blower motor having reduced current consumption configured such that an armature assembly, a brush holder assembly, and an end shield assembly are coupled to the inside of a pole housing constituting the exterior of the blower motor is configured to reduce the leakage of magnetism by a flux ring press-fitted to the outer circumferential surface of the pole housing.

However, in the case of the prior blower motor to which the flux ring is applied, the flux ring is installed on the outer side of the housing and the entire volume of the blower motor is increased. Accordingly, the installation area of the blower motor is required to be secured and it is difficult to make the blower motor compact.

In addition, the flux ring is installed on the outer circumferential surface of the housing by protruding therefrom, and thus the appearance of the blower motor is not beautiful, and the flux ring is coupled to the housing in a forcible press-fitting method and thus in the process in which the flux ring is coupled to the housing, the housing is damaged.

### DOCUMENT OF RELATED ART

(Patent Document 1) Korean Patent Application Publication No. 10-2007-0060893

### SUMMARY OF THE INVENTION

Accordingly, the present disclosure has been made keeping in mind the above problems occurring in the related art, and the present disclosure is intended to propose a motor having a flux ring in which a flux ring is fastened to a flux ring fastening part formed along the circumferential surface of a yoke so as to prevent the leakage of magnetism.

In order to achieve the above objective, according to one aspect of the present disclosure, a motor having a flux ring of the present disclosure includes: a yoke configured as a tubular body having a hollow inside; an armature assembly configured by winding a coil in a core slot formed on a core, the armature assembly being disposed inside the yoke and configured to rotate relative to a rotating shaft of the armature assembly; an ND magnet installed to be spaced apart from the armature assembly along a circumferential surface thereof, the ND magnet being press-fitted to an inner surface of the yoke to form a magnetic field; a flux ring fastening part formed on an outer circumferential surface of the yoke by being recessed by a predetermined depth therefrom; and a flux ring installed inside the flux ring fastening part and configured to prevent leakage of magnetism.

Opposite ends of the yoke may be fixedly coupled to each other by a clinching process, and a clinching part of the yoke formed by the clinching process may be chamfered.

The motor may further include: a magnet fastening groove formed in the inner surface of the yoke by being recessed by a predetermined depth therefrom such that a portion of the ND magnet is disposed in the magnet fastening groove.

The portion of the ND magnet may be forcibly press-fitted into the magnet fastening groove and may be fastened to the inner surface of the yoke.

The flux ring may be configured to have the same diameter as a diameter of the yoke.

The motor having a flux ring according to the present disclosure has the following effects.

In the motor of the present disclosure, the flux ring fastening part may be formed on the outer surface of the yoke by being recessed therefrom, and the flux ring may be coupled to the outer surface of the yoke, thereby increasing the thickness of a portion of the yoke in which a magnetic field is formed so as to prevent the leakage of magnetism.

Accordingly, as the thickness of the yoke decreases, the leakage of magnetism of the ND magnet may increase, but as the thickness of the yoke increases, the leakage of magnetism of the ND magnet may decrease, and thus the flux ring may be additionally installed, thereby minimizing the leakage of magnetism and increasing the efficiency of the motor.

In addition, although the entire thickness of the yoke decreases due to the arrangement of the flux ring in the flux ring fastening part, the leakage of magnetism may be prevented by the flux ring provided in the portion in which a magnetic field is formed, and the yoke may have a smaller thickness compared to an existing yoke, thereby reducing the weight of the motor.

In addition, the clinching part of the yoke may be chamfered and a burr may be removed from a fractured surface thereof, thereby preventing a gap between the ND magnet and the yoke by a forcible press-fitting of the ND magnet.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view illustrating the configuration of a motor having a flux ring according to an exemplary embodiment of the present disclosure;

FIG. 2 is a sectional view illustrating the configuration of the motor according to the exemplary embodiment of the present disclosure;

FIG. 3 is an exploded perspective view illustrating the configuration of the motor according to the exemplary embodiment of the present disclosure;

FIG. 4 is an exploded perspective view illustrating a state in which the flux ring is separated from a yoke according to the embodiment of the present disclosure;

FIG. 5 is a perspective view illustrating the configuration of the yoke according to the embodiment of the present disclosure;

FIG. 6 is a front view illustrating the configuration of the yoke according to the embodiment of the present disclosure;

FIG. 7 is a perspective view illustrating the configuration of the flux ring constituting the motor according to the embodiment of the present disclosure; and

FIG. 8 is an enlarged view illustrating a state in which a chamfer is formed on a clinching part formed inside the yoke by a clinching process according to the embodiment of the present disclosure.

### DETAILED DESCRIPTION OF THE INVENTION

Hereinafter, an exemplary embodiment of a motor having a flux ring according to the present disclosure will be described in detail with reference to the accompanying drawings.

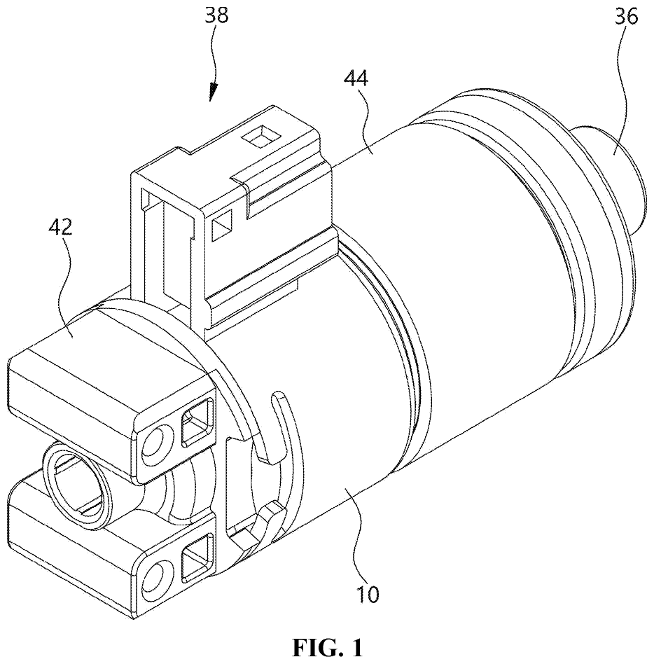

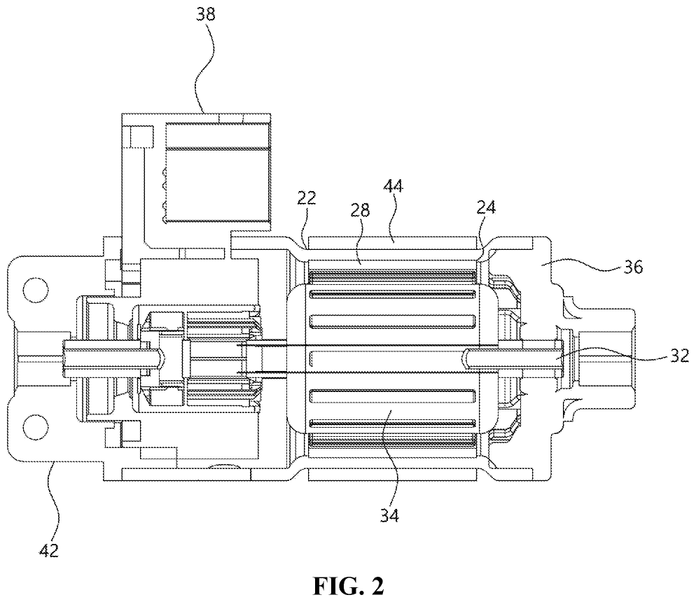

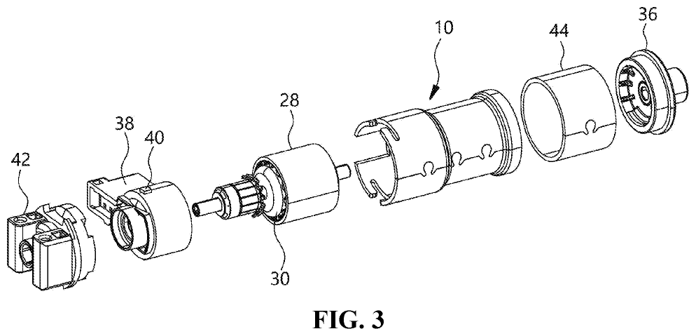

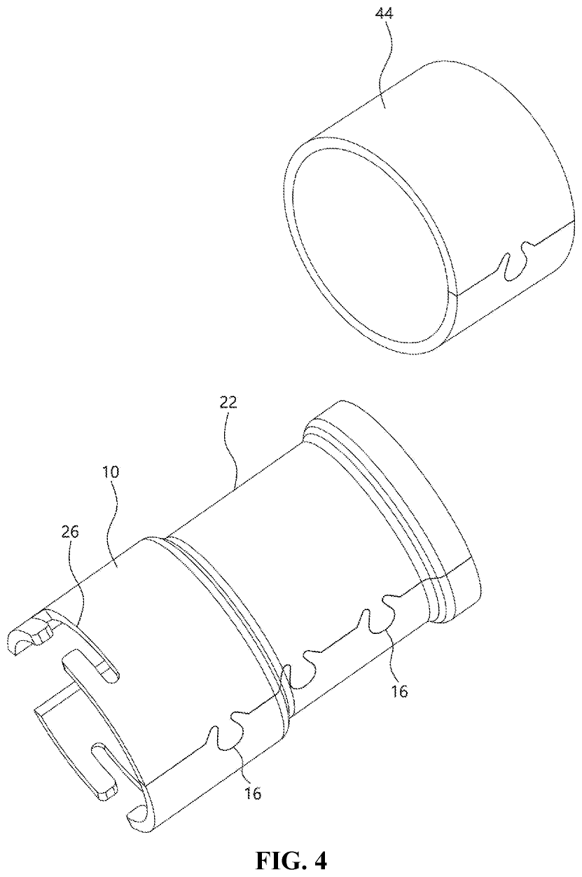

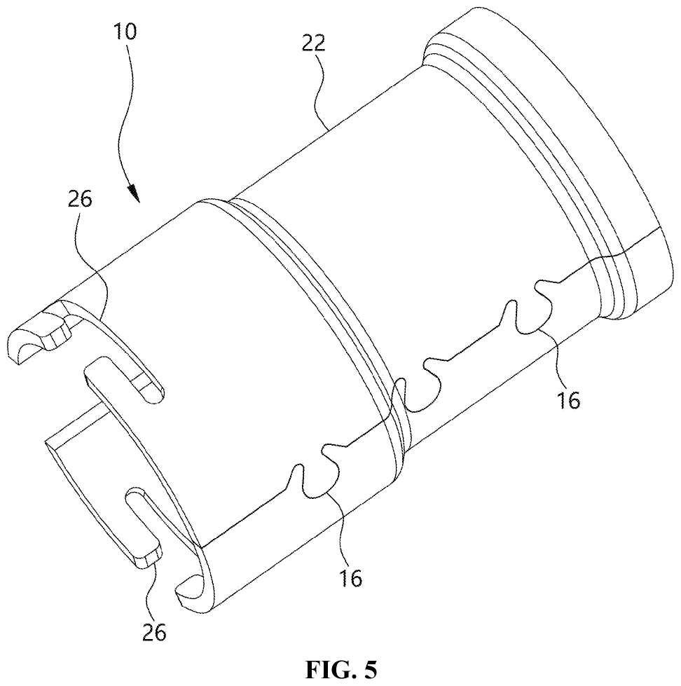

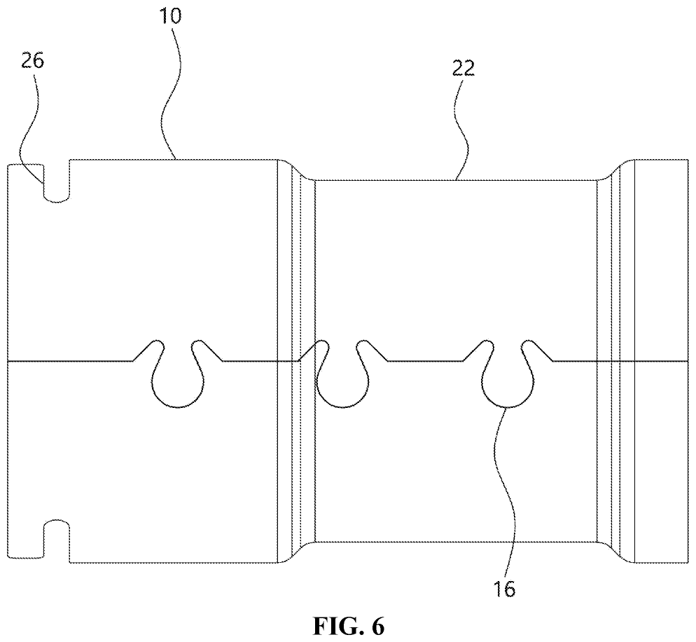

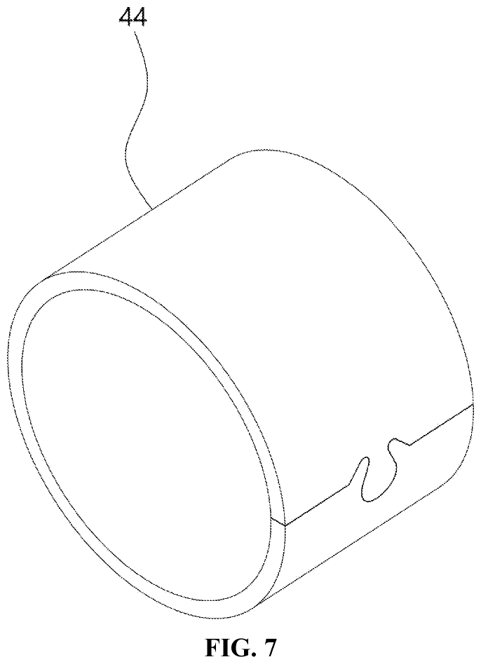

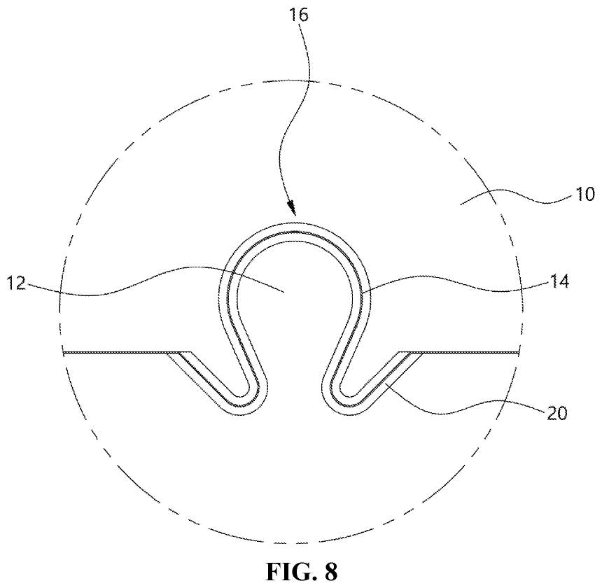

FIG. 1 is a perspective view illustrating the configuration of the motor having a flux ring according to an exemplary embodiment of the present disclosure; FIG. 2 is a sectional view illustrating the configuration of the motor according to the exemplary embodiment of the present disclosure; FIG. 3 is an exploded perspective view illustrating the configuration of the motor according to the exemplary embodiment of the present disclosure; FIG. 4 is an exploded perspective view illustrating a state in which the flux ring is separated from a yoke according to the embodiment of the present disclosure; FIG. 5 is a perspective view illustrating the configuration of the yoke according to the embodiment of the present disclosure; FIG. 6 is a front view illustrating the configuration of the yoke according to the embodiment of the present disclosure; FIG. 7 is a perspective view illustrating the configuration of the flux ring constituting the motor according to the embodiment of the present disclosure; and FIG. 8 is an enlarged view illustrating a state in which a chamfer is formed on a clinching part formed inside the yoke by a clinching process according to the embodiment of the present disclosure.

As illustrated in these drawings, the motor having the flux ring according to the present disclosure may include: the yoke 10 configured as a tubular body having a hollow inside, an armature assembly configured by winding a coil in a core slot formed on a core, the armature assembly being disposed inside the yoke 10 and configured to rotate relative to a rotating shaft, an ND magnet 28 installed to be spaced apart from the armature assembly 30 along the circumferential surface thereof, the ND magnet 28 being press-fitted to the inner surface of the yoke 10 to form a magnetic field, a flux ring fastening part 22 formed on the outer circumferential surface of the yoke 10 by being recessed by a predetermined depth therefrom, and the flux ring 44 installed inside the flux ring fastening part 22 and configured to prevent leakage of magnetism.

Hereinafter, the yoke and the armature assembly will be described in detail with reference to the accompanying drawings.

The yoke 10 may be configured as a hollow tubular body open at left and right sides thereof such that the yoke is long in a left-to-right direction. The yoke 10 may constitute the exterior of the motor, and may function to protect parts installed in the motor.

The yoke 10 may be manufactured by the clinching process as illustrated in FIG. 5, and the clinching process is a general clinching process and thus detailed description thereof will be omitted. A plurality of protruding parts 12 having “a” shapes and a plurality of insertion holes 14 having “Ω” shapes may be formed respectively on the opposite ends of the yoke 10 and may be bent by the clinching process so as to couple the protruding parts 12 and the insertion holes 14 to each other such that the clinching part 16 can be formed. Through this, the yoke 10 having a cylindrical shape may be manufactured.

In addition, a chamfering process in which the chamfer 20 is formed on the clinching part 16 may be performed. The chamfering process is a general chamfering process, so detailed description thereof will be omitted. Due to the formation of the chamfer 20 on the clinching part 16 by the chamfering process, a burr may be removed from a surface of a metal plate cut to manufacture the yoke 10.

Accordingly, a burr may be removed from the clinching part 16, and thus in the process in which the ND magnet 28 to be described later is press-fitted to a magnet fastening groove 24, a gap between the ND magnet 28 and the inner surface of the yoke which may occur due to a burr may be prevented. Accordingly, the ND magnet 28 to be described later may be more securely assembled with the inner surface of the yoke 10.

The flux ring fastening part 22 may be formed on the outer surface of the yoke 10. The flux ring fastening part 22 may be formed along the right outer circumferential surface of the yoke 10 by being recessed by a predetermined depth therefrom. The flux ring fastening part 22 may be a part formed by being recessed to have a shape corresponding to the flux ring 44 to be described later such that the flux ring 44 to be described later is inserted into and fastened to the flux ring fastening part 22.

In addition, the magnet fastening groove 24 may be formed in the inner surface of the yoke 10. The magnet fastening groove 24 may be formed along the right inner circumferential surface of the yoke 10 by being recessed by a predetermined depth therefrom. As illustrated in FIG. 2, the magnet fastening groove 24 may be a part which is formed in the inner surface of the yoke 10 and to which a portion of the ND magnet 28 to be described later is inserted into and fastened in a forcible press-fitting method.

A brush holder fastening hole 26 may be formed in the left end of the yoke 10. The brush holder fastening hole 26 may be formed to have a “┤” shape vertically through each of the upper and lower sides of the left end of the outer circumferential surface of the yoke 10. A fastening protrusion 40 of fastening a brush holder 38 to be described later may be inserted into and fastened to the brush holder fastening hole 26.

The ND magnet 28 may be installed in the magnet fastening groove 24 of the yoke 10. The ND magnet 28 is a general ND magnet, so detailed description thereof will be omitted. The ND magnet 28 may include a plurality of ND magnets installed on the inner surface of the yoke 10. The ND magnet 28 may be press-fitted into the magnet fastening groove 24 in a forcible insertion method. The ND magnet 28 may be installed inside the yoke 10 and may function to form a magnetic field.

The armature assembly 30 may be installed inside the yoke 10. The armature assembly 30 may receive power from the outside and convert electrical energy into rotational energy. Through this, the armature assembly 30 may rotate relative to the yoke 10. When the armature assembly 30 rotates, the rotating shaft 32 located at the center of the armature assembly may rotate and may transmit a rotational force to a gear assembly (not shown). The rotating shaft 32 may be coupled to the center of the armature assembly 30 and thus may be considered as a rotation center of the armature assembly 30. A core 34 may be formed on the frame of the armature assembly 30, and may be configured as an approximate cylindrical shape to surround the periphery of the rotating shaft relative thereto.

The core 34 may be configured by piling multiple core plates on each other. Each of the core plates may be made of a thin metal plate, and when core plates having the same shapes are piled on each other, the piled core plates may have a three-dimensional shape as illustrated in FIG. 2. A coil (not shown) may be wound on the core 34. The coil may be repeatedly wound in the core slot (not shown) extending radially from the core so as to constitute the armature assembly 30.

A first cover 36 may be installed on the right end of the yoke 10. The first cover 36 may have a hollow cylindrical shape, and may be partially inserted into and fastened to the right open part of the yoke 10. The first cover 36 may be inserted into and fastened to the right open part of the yoke 10 and may function to close the right open part of the yoke 10.

The brush holder 38 may be installed on the left end of the yoke 10. The brush holder 38 is a general brush holder, so detailed description thereof will be omitted. The brush holder 38 may be provided between a brush (not shown) and a brush spring (not shown) and may support the brush. The brush holder 38 may transmit an electric current applied from the outside through a main power supply part (not shown) to the armature assembly 30.

The fastening protrusion 40 may be formed on each of the upper and lower surfaces of the brush holder 38. The fastening protrusion 40 may be configured to have a cylindrical shape, and may be formed on each of the upper and lower surfaces of the brush holder 38 by protruding by a predetermined height therefrom. The fastening protrusion 40 may be rotated in one direction while being inserted into the brush holder fastening hole 26 formed in the yoke 10. The fastening protrusion 40 may be inserted into and fastened to the brush holder fastening hole 26 and thus the brush holder 38 may be securely fastened to the left end of the yoke 10.

A second cover 42 may be installed on the left end of the brush holder 38. The second cover 42 may be configured to have a cylindrical shape having a hollow inside and may be inserted into and fastened to the left end of the yoke 10 while the brush holder 38 is fastened to the yoke 10. The second cover 42 may be fixedly coupled to the left open part of the yoke 10 and may function to close the left open part of the yoke 10.

The flux ring 44 may be installed on the outer surface of the flux ring fastening part 22. The flux ring 44 may be made of metal, and may be configured as a tubular body having a hollow ring shape. The flux ring 44 may be configured to have a diameter of the same size as the size of the outer diameter of the yoke 10. The flux ring 44 may be inserted into and coupled to the flux ring fastening part 22, and may function to increase the thickness of the yoke 10 and to prevent the leakage of magnetism.

Accordingly, in the motor having a flux ring according to the present disclosure, the clinching part 16 of the yoke 10 may be chamfered and thus a burr of a fractured surface thereof occurring in a cutting process may be removed therefrom, whereby a gap which may occur between the ND magnet 28 and the inner surface of the yoke 10 in the process of forcibly press-fitting the ND magnet 28 may be prevented.

In addition, the flux ring fastening part 22 may be formed on the outer surface of the yoke 10 by being recessed therefrom, and the flux ring 44 may be coupled to the outer surface of the yoke 10, whereby the thickness of the portion of the yoke 10 in which a magnetic field is formed may be increased and the leakage of magnetism may be prevented.

That is, as the thickness of the yoke 10 decreases, the leakage of the magnetism of the ND magnet 28 may be increased, but as the thickness of the yoke 10 increases, the leakage of the magnetism of the ND magnet 28 may be decreased. Accordingly, the flux ring 44 may be additionally installed so as to minimize the leakage of magnetism and increase the efficiency of the motor.

In addition, the flux ring 44 may be inserted into and fastened to the flux ring fastening part 22, thereby beautifying the overall appearance of the motor and designing the motor such that the entire size thereof is compact.

Furthermore, the magnet fastening groove 24 may be formed inside the yoke 10, and the ND magnet 28 may be securely fastened to the inner surface of the yoke 10 by forcibly press-fitting the ND magnet 28 to the yoke, thereby improving a force to fasten the ND magnet 28 and decreasing an area to install the ND magnet 28.

In the above, even if all components constituting the motor according to the embodiment of the present disclosure have been described as being combined integrally with each other or being operated in combination integrally with each other, the present disclosure is not necessarily limited to this embodiment. That is, as long as it is within the scope of the present disclosure, at least two of all of its components may be selectively combined with each other to be operated. In addition, terms such as “include”, “constitute”, or “have” described above mean that the associated components may be inherent unless otherwise stated, so the terms should be construed not to exclude other components but to further include the other components. All terms, including technical and scientific terms, have the same meaning as commonly understood by those skilled in the art to which the present disclosure belongs, unless otherwise defined. Terms commonly used, such as those defined in the dictionary, should be construed as being consistent with the contextual meaning of the related art, and should not be construed in an ideal or excessively formal sense unless explicitly defined in the present disclosure.

The above description is merely illustrative of the technical spirit of the present disclosure, and various modifications and variations will be possible without departing from the essential characteristics of the present disclosure by those skilled in the art to which the present disclosure pertains. Accordingly, the embodiment disclosed in the present invention is for explaining rather than limiting the technical spirit of the present disclosure, and the scope of the technical spirit of the present disclosure is not limited by the embodiment. The protection scope of the present disclosure should be construed by the following claims, and all technical ideas within a scope equivalent thereto should be construed as being included in the scope of the present disclosure.

What is claimed is:

1. A motor having a flux ring, the motor comprising:
a yoke configured as a tubular body having a hollow inside;
an armature assembly configured by winding a coil in a core slot formed on a core, the armature assembly being disposed inside the yoke and configured to rotate relative to a rotating shaft of the armature assembly;
an ND magnet installed to be spaced apart from the armature assembly along a circumferential surface thereof, the ND magnet being press-fitted to an inner surface of the yoke to form a magnetic field;
a flux ring fastening part formed on an outer circumferential surface of the yoke by being recessed by a predetermined depth therefrom; and
a flux ring installed inside the flux ring fastening part and configured to prevent leakage of magnetism.

2. The motor of claim 1, wherein opposite ends of the yoke are fixedly coupled to each other by a clinching process, and a clinching part of the yoke formed by the clinching process is chamfered.

3. The motor of claim 1, further comprising:
a magnet fastening groove formed in the inner surface of the yoke by being recessed by a predetermined depth therefrom such that a portion of the ND magnet is disposed in the magnet fastening groove.

4. The motor of claim 3, wherein the portion of the ND magnet is forcibly press-fitted into the magnet fastening groove and is fastened to the inner surface of the yoke.

5. The motor of claim 1, wherein the flux ring is configured to have the same diameter as a diameter of the yoke.

6. The motor of claim 1, further comprising:
a brush holder fastening hole formed to have a “┤” shape vertically through a side of the yoke.

7. The motor of claim 6, further comprising:
a brush holder comprising a plurality of brushes provided on an end of the yoke, and
a fastening protrusion formed on an outer circumferential surface of the brush holder by protruding by a predetermined height therefrom in one direction, the fastening protrusion being inserted into and fastened to the brush holder fastening hole such that the brush holder is fastened to the yoke.
